(19) United States
(12) Patent Application Publication
(10) Pub. No.: US 2023/0150415 A1
(43) Pub. Date: May 18, 2023

(54) SECURE AND MOBILE RETAIL STRUCTURE

(71) Applicant: Aaron MURPHY, Maple (CA)

(72) Inventor: Aaron MURPHY, Maple (CA)

(21) Appl. No.: 17/529,773

(22) Filed: Nov. 18, 2021

(51) Int. Cl. B60P 3/025; E04B 1/344; E04H 15/08; B62D 63/06; B62D 63/02

(52) U.S. Cl. CPC B60P 3/0257; B60P 3/0255; B62D 63/025; B62D 63/061; E04B 1/3442; E04H 15/08

(57) ABSTRACT

A secure and mobile retail structure for securely storing and selling restricted access products is provided. In one embodiment, a vault wall located between a first end wall and a second end wall dividing the interior volume, from the vault wall to the first end wall, into a vault area for securely storing therein the restricted access products, and, from the vault wall to the second end wall, into a service area for serving customers. The vault wall comprises a secure access doorway to provide restricted access to the vault area from the service area. In some embodiments, the structure compromises one or more passive mobility means operable to be used for moving said structure from one location to another location. In some embodiments, the structure is integrated into a motorized vehicle.

### FIELD OF THE INVENTION

The present disclosure relates to a retail structure, more specifically, but not by way of limitation, more particularly to a secure and mobile retail structure for securely storing therein and selling therefrom one or more restricted access products.

### BACKGROUND

Any discussion of the related art throughout the specification should in no way be considered as an admission that such related art is widely known or forms part of common general knowledge in the field.

Recreational cannabis sales, since its legalization in several countries and states, are continuously rising. Sales of cannabis at venue and event space is an untapped market that has the potential of growing these sales higher. The sale of recreational cannabis at venue and special events space is currently illegal in most countries and states. Government regulatory department in certain jurisdictions have, however, shown an interest in allowing venue and event sales, provided that they satisfy certain regulations in regard to safety and security requirements.

CA Pub. No. 3,039,555 A1 (Neiman et al.) discloses a secured customer access arrangement for a container business. A container is provided which is modified to operate for a secure business (e.g., a retail business for the sale of a restricted access product). A security checkpoint is provided in the security vestibule. Doors are offset from each other such that restricted access space is not visible to a visitor without passing the security checkpoint. A method for permitting access to a restricted access product for sale through a modified container is also provided. Shortcomings include an inability to be actively mobile, such as being integrated into a motorized vehicle.

U.S. Pub. No. 2010/0064600 A1 (Napier) discloses a transportable building system including at least partially erecting a building, transporting the at least partially erected building on its side to a building location, locating the at least partially erected building on a support at the building location, and orientating the at least partially erected building so that it is correctly orientated relative to its support. Further disclosed is a transportable building, including a first structural component, a second structural component and a hinge coupling the first and second structural components whereby the second structural component is pivotable between a folded position and an unfolded erected position of the building. The hinge is reconfigurable to allow the second structural component to be relatively displaced away from the first structural component in the unfolded erected position of the second structural component. Shortcomings include an inability to be used as a retail store, a lack of secure area for storing restricted access products.

U.S. Pat. No. 3,182,424 A (Betjemann) discloses a combination of shipping container and showcase adapted to provide a portable mobile trade fair comprising a rectangular shipping box having four vertical corner posts attached to and supporting a rectangular floor and roof at their respective corners, two opposed end walls being connected to and extending between adjacent pairs of said corner posts and a pair of side doors each having a height and length substantially equal, respectively, to the distance between said floor and roof and the distance between said opposed end walls, said pair of side doors being hingedly connected at one longitudinal edge of each thereof to opposed longitudinal side edges of said roof, whereby said doors may be raised to form a canopy and when lowered form the side walls of said box, a central bulkhead extending between said opposed end walls dividing said box into two main sections, removable partitions dividing said main sections into alcoves for display purposes, said floor having skid channels opening to the exterior of said box and said corner posts having fittings on the upper ends thereof whereby said box may be lifted by engaging said skid channels or said fittings, and retractable legs pivotally connected to said side doors adjacent the longitudinal edges thereof opposite the hingedly connected edges thereof to maintain them in their raised position to expose the interior of said ‘box for display purposes. Shortcomings include a lack of a secure area for storing restricted access products and an inability to be actively mobile, such as being integrated into a motorized vehicle.

U.S. Pat. No. 5,815,988 A (Molina) discloses an expandable retractable portable structure. The expandable retractable portable structure having a movable portion hingedly connected to a stationary portion and wherein the movable portion pivotally encloses the stationary portion of the structure in its retracted position and wherein, in its expanded position, the structure provides maximum interior space for use. An actuating mechanism includes one or more hydraulic or pneumatic cylinders connected to a linkage system. The actuator is located inside the structure on the floor of the stationary portion and the linkage system driven by the actuator is connected to the floor of the movable portion so that the movable portion is rotated by the actuator and linkage system between its expanded and retracted positions. The actuator and linkage system are removably mounted inside the structure and may be readily removed from the structure and used to open or close other structures. Alternatively, the actuator may be left inside the structure. Shortcomings include an inability to be used as a retail store, a lack of a secure area for storing restricted access products and an inability to be actively mobile, such as being integrated into a motorized vehicle.

U.S. Pat. No. 7,044,052 B2 (Van Der Touw et al.) discloses transportable recycling center. The transportable recycling center has a container and a partition within the container. The partition separates a work area from a storage area. An attendant may accept recyclable materials from consumers in the work area and store the recyclable material in the storage area. After the container has been filled with recyclable material, doors on the container may be secured and the container may be loaded onto a truck and transported to a recycling facility. Shortcomings include a lack of a secure area for storing and selling restricted access products, and an inability to be actively mobile, such as being integrated into a motorized vehicle.

U.S. Pat. No. 8,636,208 B2 (Urban et al.) discloses a mobile retail store structure with inventory system. The mobile retail store structure transportable to a plurality of different locations includes a trailer construction configured both exteriorly and interiorly for housing a plurality of storage bins wherein products and/or parts can be stored. Each trailer is a self-sufficient module which includes doors at one end of the trailer unit for entry and exit thereto, portable stairs for providing access to the entry doors, opposed side doors and associated walkways for allowing coupling to additional similarly constructed trailers, extendable canopies for providing a secure passageway between the respective coupled trailers, and a generator/HVAC system for providing heating, cooling and electrical power to each trailer unit. In one embodiment, a terminal is provided to allow a user to either browse electronically various items for selection and/or sale or access a self-service check-out station to complete a transaction. A plurality of terminals can be coupled to communicate with a master server terminal over a wired/wireless network. Shortcomings include a lack of a secure area for securely storing restricted access products an inability to be actively mobile, such as being integrated into a motorized vehicle.

U.S. Pat. No. 10,269,273 B1 (Borden) discloses a mobile showroom and advertising system. The mobile truck body has a first panel extending forward from the front of a right side truck body panel and a second panel extending rearward from the rear of the right side truck body panel. The first and second panels extend the display area of the right side truck body panel. An upper panel and/or a lower panel are also provided at the right side truck body panel to provide access to an interior space of the truck body for showcasing products or services, and a lower platform is provided to facilitate customer ingress and egress into and out of the showcase. Shortcomings include a lack of a secure area for securely storing restricted access products.

U.S. Pat. No. 10,518,832 B2 (Kamm) discloses a self-contained mobile retail store structure which is transportable from one location to another. The structure is mounted to a frame which is coupled to a plurality of wheels by a hydraulic system capable of raising, lowering, inclining and declining the structure relative to a ground surface. In a stationary position, the walls of the structure contact the ground surface, and in the transportable position, the walls of the structure are spaced from the ground surface. The mobile retail store structure of this disclosure fits in a standard-sized parking space and may be configured with other similar structures to expand the retail area. Shortcomings include a lack of a secure area for securely storing restricted access products and an inability to be actively mobile, such as being integrated into a motorized vehicle.

U.S. Pat. No. 10,793,998 B2 (Sights et al.) discloses an outdoor retail space structure. The structure has spaces that can accommodate at least two International Organization for Standardization compliant shipping containers. The structure has studs, joists, and rafters connected together above, beside, between, and in front of the spaces for the shipping containers. The structure provides for an attractive outdoor retail space with shading, allowing for signage, decorations, product display, ergonomics, and other retail design features. In an implementation, the structure is for a mobile retail space that is tailored for customizing and manufacture of the customized apparel, especially the laser finishing of products like jeans. The mobile retail space can be relocated to and deployed easily at various events, such as sports events and music festival venues. Shortcomings include a lack of a secure area for storing restricted access products and an inability to be actively mobile, such as being integrated into a motorized vehicle.

All documents cited herein are incorporated by reference.

### BRIEF SUMMARY

It is an object of the invention to provide a secure and mobile retail structure.

In accordance with one aspect, there is provided a retail structure for securely storing and selling one or more restricted access products, the structure comprising: a rectangular base, a first end wall and a second end wall, a first side wall and a second side wall, and a roof portion, thereby defining an interior volume of said structure; a vault wall located between said first end wall and said second end wall, extending horizontally from the first side wall to the second side wall and vertically from the base to the roof portion, thereby dividing the interior volume, from the vault wall to the first end wall, into a vault area for securely storing therein the restricted access products, and, from the vault wall to the second end wall, into a service area for serving customers; a secure access doorway situated within the vault wall to provide restricted access to the vault area from the service area; wherein at least one of said first side wall and said second side wall, in said service area, comprises a service opening therein.

In one embodiment, the at least one of said first side wall and said second side wall comprises, below the service opening, a service counter.

In one embodiment, the base compromises one or more passive mobility means operable to be used for moving said structure from one location to another location.

In one embodiment, the one or more passive mobility means comprise one or more apertures for moving the structure with a hydraulic lift.

In one embodiment, the secure access doorway comprises: a half-door hingedly coupled to a vertical edge of said secure access doorway, and covering a bottom portion of said secure access doorway; and a window panel covering a top portion of said secure access doorway, the window panel comprising therein a transfer aperture for securely transferring a small quantity of the one or more restricted access products therethrough from the vault area into the service area, the window panel having a bottom edge substantially aligned with a top edge of said half-door.

In one embodiment, the transfer aperture is substantially rectangular and comprising a bottom edge substantially aligned with the bottom edge of the window panel.

In one embodiment, the half-door comprises a counter portion extending towards the service area having an upper surface adjacent to the top edge of the half-door.

In one embodiment, the half-door comprises a lock assembly that locks the half-door from inside the vault area.

In one embodiment, the retail structure further comprises an awning above the service opening.

In one embodiment, the awning comprises: a substantially rigid and rectangular awning panel horizontally pivotally connected to said at least one of said first side wall and said second side wall of said service opening, outside of said structure, at an upper edge of or above said service opening, and configured to be pivotally moved between: an open configuration wherein the awning panel is substantially horizontal; and a closed configuration wherein the awning panel is substantially parallel and adjacent to the at least one of said first side wall and said second side wall of said service opening so as to substantially cover said service opening and prevent access to the service area therefrom.

In one embodiment, the awning panel is further configured to be pivotally moved into an advertising configuration, wherein the awning panel is positioned to be substantially vertically oriented above the service opening, the awning panel further comprising a display surface thereon for displaying a message in the advertising configuration.

In one embodiment, the retail structure further comprises a stage, the stage comprising: a substantially rigid and rectangular stage platform horizontally pivotally connected to said at least one of said first side wall and said second side wall of said service opening, outside of said structure, substantially near a bottom edge of said at least first side wall and said second side wall of said service opening, and configured to be moved between: an open configuration, wherein the stage platform is substantially horizontal to a client to stand thereon; and a closed configuration, wherein the stage platform is substantially parallel and adjacent to the at least one of said first side wall and said second side wall of said service opening so as to substantially cover said service opening and prevent access to the service area therefrom.

In one embodiment, the stage platform further comprises, pivotally coupled at an edge thereof, a ramp, the ramp configured to be pivotally moved between a deployed configuration wherein an edge thereof rests against the ground to allow the customer to walk to and from the stage, and a folded configuration wherein the ramp rests on an upper surface of said stage platform.

In one embodiment, the second end wall comprising therein an access door to access said service area from outside of said structure, the access door comprising a lock assembly.

In one embodiment, the retail structure further comprises a side awning, the side awning comprising: a rectangular side awning panel horizontally pivotally coupled along an edge thereof to said second end wall near an upper edge thereof, outside of said structure, the side awning panel being substantially rigid and configured to be pivotally moved between: an open configuration wherein the side awning panel is substantially horizontal; and a closed configuration wherein the side awning panel is substantially parallel and adjacent to the second end wall.

In one embodiment, the retail structure further comprises a releasably affixable stair assembly, optionally affixed at one end at or near an upper edge of said first end wall, outside of said structure, with an other end of the stair assembly resting on the ground; and a set of railing elements, pivotally connected to or near to edges of said roof portion; wherein the railing elements are movable into an upright configuration, thereby defining and enclosing on top of the roof portion a balcony, or folded down to rest on the roof portion.

In one embodiment, the structure is part of a motorized vehicle, the motorized vehicle further comprising a cabin portion.

In one embodiment, the first end wall of said structure is shared with the cabin portion of the motorized vehicle, wherein said first end wall further comprises a cabin access door to access the vault area from the cabin portion; and wherein said second end wall of said structure is the rear end of the motorized vehicle.

In one embodiment, the second end wall of said structure is shared with the cabin portion of the motorized vehicle, wherein said second end wall further comprises a cabin access door to access the service area from the cabin portion; and wherein said first end wall of said structure is the rear end of the motorized vehicle.

In one embodiment, at least a portion of said vault wall is hingedly connected to at least one of said first side wall or said second side wall, and operable to be pivotally moved so as to be parallel and substantially adjacent to said at least one of said first side wall or said second side wall.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

In the figures, embodiments are illustrated by way of example. It is to be expressly understood that the description and figures are only for the purpose of illustration and as an aid to understanding.

Embodiments will now be described, by way of example only, with reference to the attached figures, wherein the figures:

FIGS. 1A to 1G are perspective views of a mobile and secure retail structure, in accordance with different embodiments.

FIG. 2 is a perspective view of a secure and mobile retail structure that is integrated into a motorized vehicle, in accordance with one embodiment.

FIGS. 3A to 3C are perspective views of a secure and mobile retail structure that is integrated into a motorized vehicle and wherein the vault area is located at the back of the vehicle, in accordance with different embodiments.

FIGS. 3D and 3E are perspective views of the interior volume of the secure and mobile retail structure that is integrated into a motorized vehicle of FIG. 3A, FIG. 3B and FIG. 3C, wherein a portion of the vault wall is hingedly coupled to a side wall and is operable to be pivotally moved from a first position (FIG. 3D) to a second position (FIG. 3E).

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The present invention provides a secure and mobile retail structure that may be used with many embodiments. As such, the general purpose of the present invention, which will be described subsequently in greater detail, is to provide a secure and mobile retail structure for securely storing therein and selling therefrom one or more restricted access products, for example cannabis products or derivatives therefrom.

It has previously been recognized that there exists a need for a secure and mobile retail structure that allows for selling restricted access products such as cannabis or derivatives thereof, that comprises a vault area for securely storing the restricted access products and that may either passively mobile or actively mobile.

The disclosure proposes a secure and mobile retail structure for securely storing therein and selling therefrom one or more restricted access products, that overcomes disadvantages inherent in the existing retail structures, such as, but not limited to, an inability to be used for retail, lack of a secure area for storing restricted access products, and an inability to be actively mobile, such as being integrated into a motorized vehicle. The present invention provides a secure and mobile retail structure that may be used with many different forms. As such, the general purpose of the present invention, which will be described subsequently in greater detail, is to provide a new and improved secure and mobile retail structure for securely storing therein and selling therefrom one or more restricted access products, which provides the advantages and overcomes the aforementioned disadvantages.

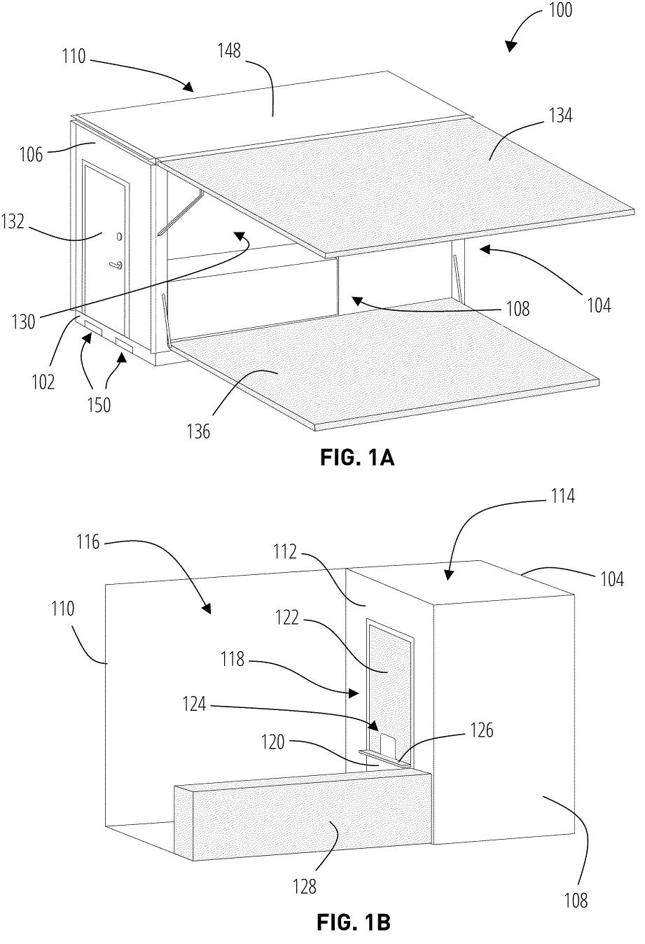

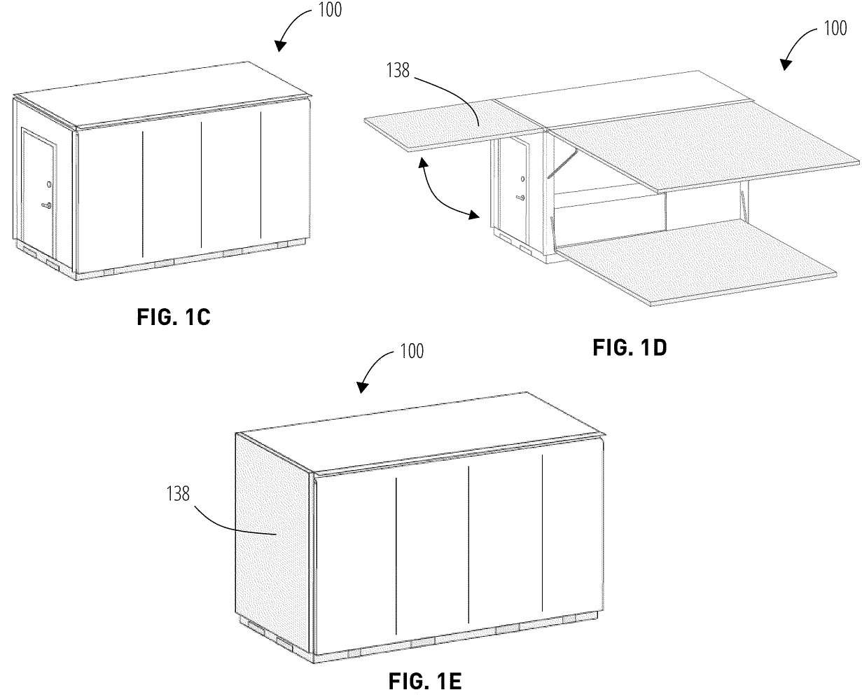

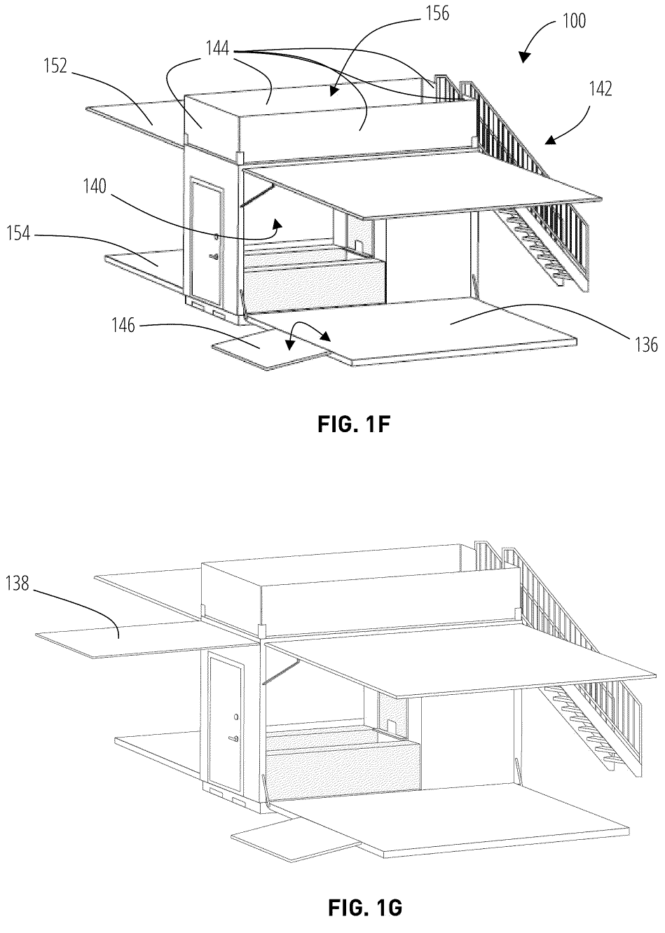

FIG. 1A shows a perspective view of the exterior of an exemplary retail structure 100 comprising a rectangular base 102, a first end wall 104, a second end walls 106, a first side wall 108, a second side wall 110, and a roof portion 148.

In some embodiments, the base 102 comprises therein one or more passive mobility means operable to be used for moving, displacing or deploying the structure 100 from one location to another location. In the example of FIG. 1A, the passive mobility means are shown as one or more hydraulic lift apertures 150 which may be used to move or displace structure 100 via a hydraulic lift. For example, this may be used to put structure 100 on a trailer to be displaced and deploy it at the new location. In other embodiments, the one or more passive mobility means may take the form of two or more wheels coupled to the base 102 and an attachment means for attaching the structure 100 to a vehicle or the like.

As shown in FIG. 1B, which shows a perspective view of the interior volume of the structure 100, a vault wall 112 is located between the first end wall 104 and the second end wall 106, extending horizontally from the first side wall 108 to the second side wall 110, and vertically from the base 102 to the roof portion, hereby dividing the interior volume of the structure 100 into a vault area 114 on one side and a service area 116 on the other. The vault area 114 is used, in part, for securely storing the one or more restricted access products, while the service area 116 is used for selling small quantities of the restricted access products to a customer located outside of structure 100. The vault wall 112 comprises therein a secure access doorway 118 for both accessing the vault area 114 and for transferring the small quantities of restricted access products from the vault area 114 to the service area 116.

The restricted access products may be cannabis products or derived cannabis products, for example oil, food (e.g., candies, cookies, brownies, etc.) or the like. In some embodiments, other types of restricted access products may also be stored and sold, for example medicine and/or drugs, including age-restricted products, such as, but not limited to products containing tobacco (e.g., cigarettes, cigars, etc.) or alcohol (such as beer, wine, spirits, etc.). In some embodiments, the vault area 114 may also be used to securely store money and/or other valuable objects.

In some embodiments, the secure access doorway 118 comprises on the bottom portion thereof a half-door 120. The half-door 120 is hingedly connected or coupled to a vertical edge of the secure access doorway 118, so as to cover the bottom portion thereof when closed. In some embodiments, the half-door 120 may be reinforced with or made of a substantially impact resistant material. The half-door 120 typically comprises a lock assembly therein. In some embodiments, this lock assembly may be configured so that the half-door 120 may be locked (and unlocked) from the inside of the vault area 114 only. Furthermore, the top portion of the secure access doorway 118 comprises a window panel 122 covering the remaining top portion of the secure access doorway 118, the window panel 122 comprising therein a transfer aperture 124 for securely transferring a small quantity of the restricted access products from the vault area 114 to the service area 116. For example, in some embodiments, an employee or person having the proper authorization may access the vault area 114 and lock himself/herself within. When a customer wishes to purchase a limited or small quantity of the restricted access products, another service employee in the service area 116 may request the desired product and quantity thereof, upon which, the authorized employee may transfer the small quantity of restricted access products through the transfer aperture 124.

In the example of FIG. 1A, the transfer aperture 124 is substantially rectangular and comprising a bottom edge that is substantially aligned with the bottom edge of the window panel 122. The size of the transfer aperture 124 should be large enough to pas s-through or transfer a small quantity of product, but not large enough to allow an arm to reach inside the vault area 114, for example to unlock the half-door 120. Different strong and substantially transparent materials may be used for the window panel 122, including for example bullet-proof glass or the like. In some embodiments, the half-door 120 may comprise a counter portion 126 adjacent to the bottom edge of the transfer aperture 124, for depositing the small quantity of restricted access product thereon. In other embodiments, the transfer aperture 124 may instead take the form of an aperture or recess in counter portion 126 instead.

Going back to FIG. 1A, the first side wall 108, in the service area 116, comprises at least one service opening 130 for selling the small quantity of restricted access products to a customer outside of structure 100. Different types of service openings may be envisioned. For example, the service opening 130 in FIG. 1A takes the form of a pass-through window. In addition, the portion of the first side wall 108 below the service opening 130 may be configured as a service counter 128 or similar, with an increased width extending inside the service area 116 and which may be used to place a cash register or similar, and/or other devices. However, the skilled person in the art will appreciate that the illustrated service opening 130 is an example only and that different numbers of openings, of different sizes and/or shapes may also be used without restriction. For example, in some embodiments, the service openings 130 may comprise a glass or plastic window, for example a slidable glass window or the like. In some embodiments, service counters may be attached or affixed to the exterior side of the first side wall 108. In some embodiments, these may be pivotally attached to the first side wall 108. In some embodiments, they may be removably attached.

The structure 100 may further comprise at least one access door to access the service area 116 from the outside. For example, in FIG. 1A, an access door 132 is shown being located in the second end wall 106. The access door 132 may comprise a lock assembly to restrict access to the structure 100 for authorized employees only.

In some embodiments, structure 100 may further comprise an awning above the service opening 130. In the example of FIG. 1A, the awning comprises a substantially rigid and rectangular awning panel 134 which is horizontally pivotally connected, outside of the structure 100, to the upper edge of the first side wall 108. The awning panel 134 may be configured to be pivotally moved between an open configuration (as seen in FIG. 1A), wherein the awning panel 134 is substantially horizontal to protect customers from the weather, and a closed configuration (seen for example in FIGS. 1C and 1D), wherein the awning panel 134 is substantially parallel and adjacent to the first side wall 108 so as to fully cover the service opening 130 and prevent access to the service area 116 therefrom.

The skilled person in the art will appreciate that different shapes and sizes of the awning panel 134 may be used, and that the awning panel 134 may be attached at any point above the service opening 130, (not only at the upper edge thereof). For example, in the case where the service opening 130 does not extend all the way to the top of the first side wall 108, the awning panel 134 could be attached at some height between the upper edge of the service opening 130 and the upper edge of the first side wall 108, as long as the awning panel 134 is correspondingly configured and/or shaped to cover the service opening 130 in the closed configuration. In some embodiments, the awning panel 134 may be configured to substantially cover the service opening 130 only, as long as it prevents an individual from reaching into the service area 116 from outside of the structure 100. In some embodiments, the awning panel 134 may be made of or reinforced with a metal material or the like. For example, in some embodiments, the awning panel 134 may be made or reinforced with a steel alloy or the like.

In some embodiments, structure 100 may further comprise a stage, the stage comprising, as illustrated in FIG. 1A, a substantially rigid and rectangular stage platform 136 horizontally pivotally connected, outside of the structure 100, substantially near the bottom edge of the first side wall 108, and configured to be pivotally moved between an open configuration wherein the stage platform 136 is substantially horizontal for a client to stand thereon, as illustrated in FIG. 1A, and a closed configuration wherein the stage platform 136 is substantially parallel and adjacent to the first side wall 108 so as to completely (or substantially) cover the service opening 130 (as illustrated in FIGS. 1C and 1D).

In some embodiments, the awning panel 134 and/or stage platform 136 may have a smaller width (along the first side wall 108) than illustrated. For example, in some embodiments, the width may be substantially close to the width of the service opening 130 only.

In some embodiments, a portable electric generator (not shown) may be provided, configured to be optionally coupled to the structure 100 to provide electricity thereto. In some embodiments, electric outlets, light fixtures and/or fans may be installed on any of the walls 104, 106, 108 and/or 110, and/or roof portion 148, and be electrically coupled to the portable electric generator. (Are the awning and the stage electrically actuated?).

FIG. 1C illustrates the structure 100 of FIG. 1A with both the awning panel 134 and stage platform 136 being in the closed configuration. In some embodiments, the structure 100 may be configured so that the awning panel 134 is folded down first to rest against and cover the service opening 130, and the stage platform 136 folded up second to rest against the awning panel 134, while in other embodiments the stage platform 136 is folded first and the awning panel 134 folded second. Thus, in the closed configuration, the awning panel 134 and/or stage platform 136 enclose the structure 100 so as to offer additional protection against forced entry in the structure 100.

FIGS. 1D and 1E illustrate the structure 100 of FIG. 1A further comprising a substantially rigid and rectangular side awning panel 138 pivotally connected to the top edge of the second end wall 106 and configured to be pivotally moved between the open configuration illustrated in FIG. 1D, and the closed configuration illustrated in FIG. 1E wherein the side awning panel 138 is substantially parallel and adjacent to the second end wall 106 so to completely cover it. In some embodiments, the side awning panel 138 may have a different shape and/or size than illustrated and be pivotally or hingedly connected at any location on the second end wall 106 between the top edge of the access door 132 and the top edge of the second end wall 106, as long as it is configured to substantially cover the access door 132 in the closed configuration to prevent access thereto. As discussed above with respect to the awning panel 134, the side awning panel 138 may be reinforced with or substantially comprise an impact resistant material such as steel or the like.

In some embodiments, as illustrated in FIG. 1F, structure 100 may further comprise additional elements or features. For example, in FIG. 1F, the second side wall 110 is shown also having a service opening 140, in addition to the service opening 130 in first side wall 108. Similarly, an awning panel 152 and a stage platform 154 are shown being pivotally connected to the second side wall 110. The skilled person in the art will appreciate that all the features described above with regard to the service opening 130, the counter portion 126, the awning panel 134 and the stage platform 136 in reference to FIG. 1A apply equally here as well for the corresponding elements part of and/or attached to the second side wall 110 named above. In addition, it will be appreciated that some embodiments may comprise either one of the service openings 130 or 140, without restriction.

In addition, FIG. 1F shows a releasably affixable stair assembly 142 which may be optionally releasably affixed at one end to or near to the upper edge of the first end wall 104, outside of the structure 100, with the other end resting on the ground. A set of railing elements 144 are also shown being pivotally connected to or near to the edges of the roof portion 148. The railing elements 144 are movable into an upright configuration, shown in FIG. 1F, thereby defining and enclosing on the upper surface of the roof portion 148 a balcony section 156, which may optionally be furnished with chairs and/or tables for example, that can be used by customers to use the restricted access product they have purchased below.

FIG. 1F further shows the stage platform 136 of structure 100 comprising a ramp panel 146 to allow a customer to walk to and from the stage platform 136. In some embodiments, the ramp panel 146 may be removably attachable along one edge thereof to a corresponding edge of the stage platform 136. In other embodiments, the ramp panel 146 may be pivotally or hingedly connected to the same edge of the stage platform 136 to be pivotally moved into a deployed position wherein the opposite edge of the ramp panel 146 rests on the ground (as illustrated in FIG. 1F), and a folded position wherein the ramp panel 146 is pivoted or folded back to rest on the top surface of the stage platform 136 (not shown).

FIG. 1G shows the embodiment of structure 100 of FIG. 1F, further comprising the side awning panel 138 first discussed with reference to FIG. 1D, in accordance with one embodiment.

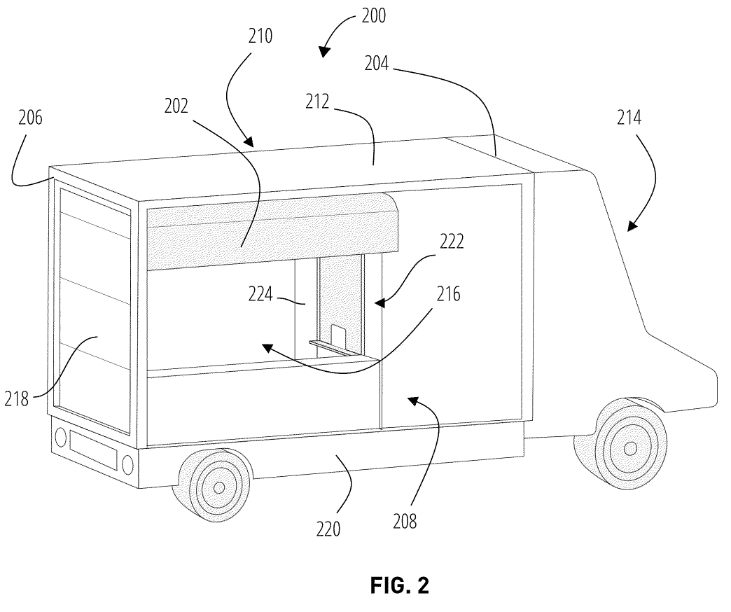

FIG. 2 illustrates an exemplary embodiment in which the retail structure 200 integrated into a motorized vehicle. The embodiments where the retail structure is part of a motorized vehicle are, unlike the embodiments illustrated in FIGS. 1A to 1G, actively displaceable without having to be moved, for example via a hydraulic lift or other vehicle. The retailer or seller of the one or more restricted access products may thus drive the vehicle to a desired and/or suitable location as required. Any type of motorization may be considered, including gas vehicles, electric vehicles or hybrid vehicles, without restriction. In FIG. 2, the vehicle is illustrated as a delivery truck as an example only, and the skilled person in the art will appreciate that other vehicular designs may also be considered.

FIG. 2 shows an embodiment comprising a structure 200 integrated with a cabin portion 214 of a motorized vehicle. Similarly, to the embodiments discussed above, the structure 200 comprises a base 220 (which may be part of the vehicle’s lower portion), a first side wall 208, a second side wall 210, a first end wall 204, a second end wall 206 and a roof portion 212. The vault wall 224 comprising the secure access doorway 222 divides the interior volume of the structure 200 into the service area and vault area discussed above.

In the exemplary embodiment of FIG. 2, the first end wall 204 is shared with the back wall of the cabin portion 214, while the second end wall 206 is at the back of the vehicle. The second end wall 206 has an access door 218. In FIG. 2, the access door 218 is shown to be a roll-up door, but other types of doors may be used as well, for example swing doors or the like.

FIG. 2 shows a pull-down barrier 202 located above the service opening 216 that can be rolled down to cover the opening.

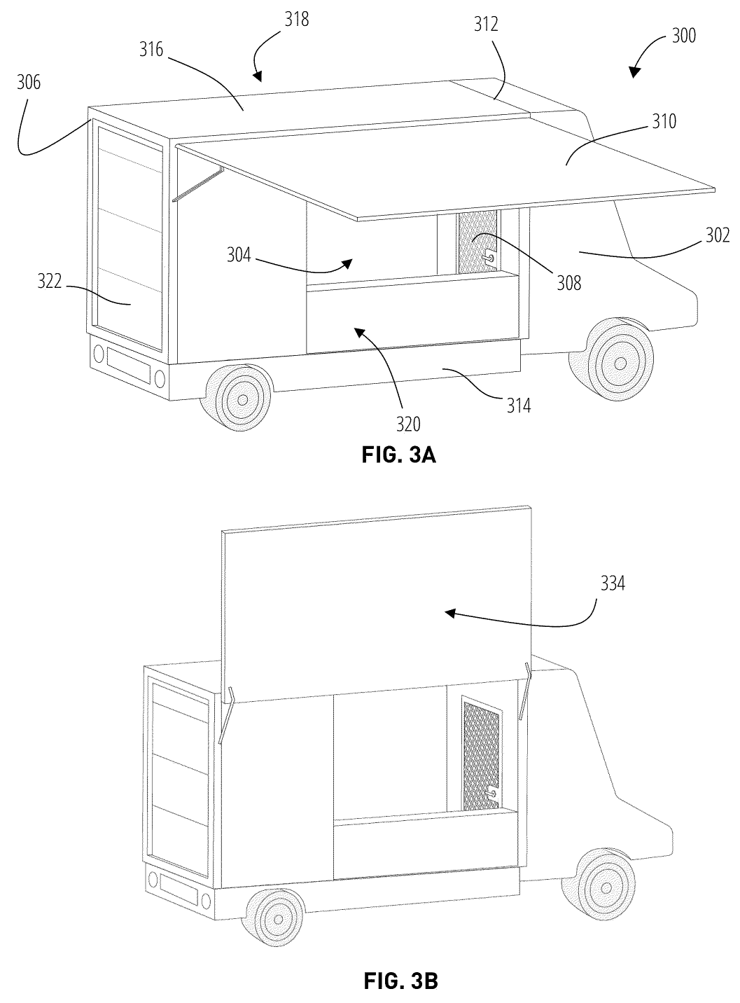

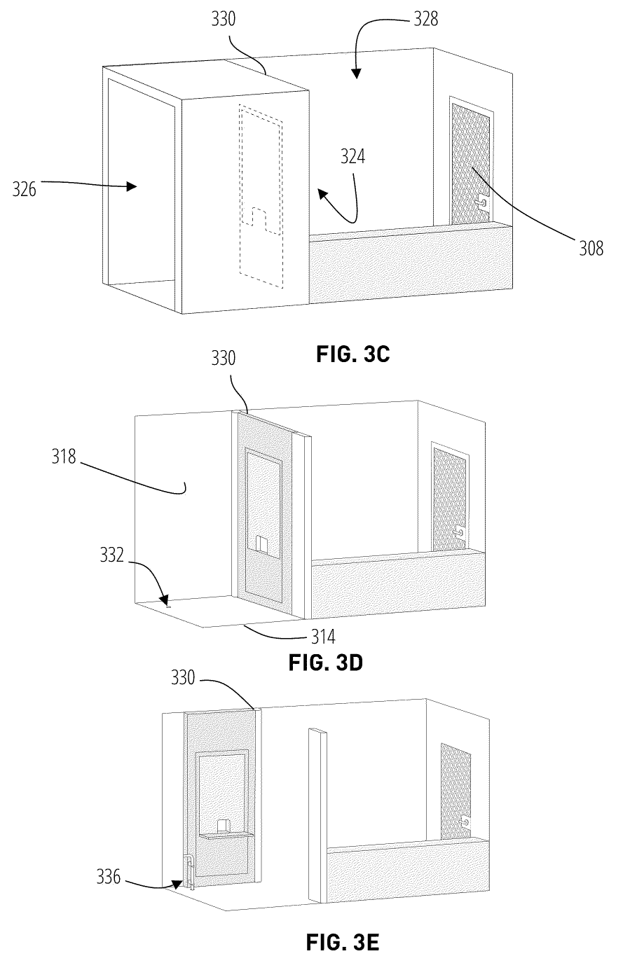

With reference to FIGS. 3A to 3E, and in accordance with different embodiments, other examples of the retail structure being integrated into a motorized vehicle, generally referred to using the numeral 300, will now be described.

The embodiments of FIGS. 3A to 3E have similar features as those described in the embodiment of FIG. 2. For example, it comprises the base 314, the first side wall 320, second side wall 318, first end wall 306, second end wall 312, and roof portion 316. However, the embodiments of FIGS. 3A to 3E have the vault area 326 (FIG. 3C) located at the back of the vehicle, and the service areas 328 adjacent to the cabin portion 214. For example, in FIG. 3A, the second end wall 312 is shared with the back wall of the cabin portion 302, while the first end wall 306 is the back side of the motorized vehicle. The access door 322 is therefore on the first end wall 306 and is again shown here as a roll-up door as an example only. The access door 322 may be used to access the vault area from outside of the structure 300. FIG. 3A also shows a cabin access door 308 in the second end wall 312 that can be used to access the service area from the cabin portion 302.

The structure 300 further comprises an awning panel 310, similar to the awning panel 134 (or 152) of FIGS. 1A to 1G, meaning that it can be pivotally closed to cover the service opening 304. Alternatively, or additionally, in some embodiments, the structure 300 could also comprise another service opening on the second side wall 318.

FIG. 3B illustrate an example where the awning panel 310 is also operable to be pivotally moved to an advertising configuration wherein the awning panel 310 is positioned to be substantially vertically oriented above the service opening. In this position, the awning panel further comprises a display surface 334 thereon for displaying a message in the advertising configuration.

FIGS. 3C to 3F show the interior volume of the structure 300. FIG. 3C clearly shows the vault wall 330 dividing the interior volume into the vault area 326 and the service area 328. Also shown are the cabin access door 308 and the secure access doorway 324.

FIGS. 3D and 3E show an inside view of the vault area 326 with the vault wall 330 being configured so as to have at least a portion thereof that is movable and hingedly connected to the second side wall 318). FIG. 3D shows the vault wall 330 in a closed configuration wherein the vault wall 330 is perpendicular to the side walls and separates, at discussed above, the interior volume between the vault area 326 and the service area 328.

FIG. 3E shows the vault wall 330 (or at least a portion thereof) being pivotally moved so as to be substantially parallel and adjacent to the second side wall 318. In this configuration, the interior volume is no longer divided and the whole volume may be used for generic storage purposes or the like.

In some embodiments, the hingedly connected vault wall 330 (or portion thereof) may be affixed in either positions via a bolt mechanism or similar. For example, FIG. 3D shows a recess or hole 332 in the base 314 which can be used to reversibly affixed the vault wall 330 (or portion thereof) via a bolt 336 as shown in FIG. 3E. Although not shown, another hole may be located substantially close to the vault wall 330 in the closed configuration so as to reversibly affix the vault wall 330 (or portion thereof) in that position as well.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. As can be understood, the examples described above are intended to be exemplary only.

The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

The term “connected”, “attached”, “affixed” or “coupled to” may include both direct coupling (in which two elements that are coupled to each other contact each other) and indirect coupling (in which at least one additional element is located between the two elements).

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A retail structure for securely storing and selling one or more restricted access products, the structure comprising:
a rectangular base, a first end wall and a second end wall, a first side wall and a second side wall, and a roof portion, thereby defining an interior volume of said structure;
a vault wall located between said first end wall and said second end wall, extending horizontally from the first side wall to the second side wall and vertically from the base to the roof portion, thereby dividing the interior volume, from the vault wall to the first end wall, into a vault area for securely storing therein the restricted access products, and, from the vault wall to the second end wall, into a service area for serving customers;
a secure access doorway situated within the vault wall to provide restricted access to the vault area from the service area;
wherein at least one of said first side wall and said second side wall, in said service area, comprises a service opening therein.

2. The retail structure of claim 1, wherein the at least one of said first side wall and said second side wall comprises, below the service opening, a service counter.

3. The retail structure of claim 1, wherein said base compromises one or more passive mobility means operable to be used for moving said structure from one location to another location.

4. The retail structure of claim 3, wherein said one or more passive mobility means comprise one or more apertures for moving the structure with a hydraulic lift.

5. The retail structure of claim 1, wherein the secure access doorway comprises:
a half-door hingedly coupled to a vertical edge of said secure access doorway, and covering a bottom portion of said secure access doorway; and
a window panel covering a top portion of said secure access doorway, the window panel comprising therein a transfer aperture for securely transferring a small quantity of the one or more restricted access products therethrough from the vault area into the service area, the window panel having a bottom edge substantially aligned with a top edge of said half-door.

6. The retail structure of claim 5, wherein the transfer aperture is substantially rectangular and comprising a bottom edge substantially aligned with the bottom edge of the window panel.

7. The retail structure of claim 6, wherein said half-door comprises a counter portion extending towards the service area having an upper surface adjacent to the top edge of the half-door.

8. The retail structure of claim 6, wherein the half-door comprises a lock assembly that locks the half-door from inside the vault area.

9. The retail structure of claim 1, further comprising an awning above the service opening.

10. The retail structure of claim 9, wherein the awning comprises:
a substantially rigid and rectangular awning panel horizontally pivotally connected to said at least one of said first side wall and said second side wall of said service opening, outside of said structure, at an upper edge of or above said service opening, and configured to be pivotally moved between:
an open configuration wherein the awning panel is substantially horizontal; and
a closed configuration wherein the awning panel is substantially parallel and adjacent to the at least one of said first side wall and said second side wall of said service opening so as to substantially cover said service opening and prevent access to the service area therefrom.

11. The retail structure of claim 10, wherein the awning panel is further configured to be pivotally moved into an advertising configuration, wherein the awning panel is positioned to be substantially vertically oriented above the service opening, the awning panel further comprising a display surface thereon for displaying a message in the advertising configuration.

12. The retail structure of claim 1, further comprising:
a stage, the stage comprising:
a substantially rigid and rectangular stage platform horizontally pivotally connected to said at least one of said first side wall and said second side wall of said service opening, outside of said structure, substantially near a bottom edge of said at least first side wall and said second side wall of said service opening, and configured to be moved between:
an open configuration, wherein the stage platform is substantially horizontal to a client to stand thereon; and
a closed configuration, wherein the stage platform is substantially parallel and adjacent to the at least one of said first side wall and said second side wall of said service opening so as to substantially cover said service opening and prevent access to the service area therefrom.

13. The retail structure of claim 12, wherein said stage platform further comprises, pivotally coupled at an edge thereof, a ramp, the ramp configured to be pivotally moved between a deployed configuration wherein an edge thereof rests against the ground to allow the customer to walk to and from the stage, and a folded configuration wherein the ramp rests on an upper surface of said stage platform.

14. The retail structure of claim 1, the second end wall comprising therein an access door to access said service area from outside of said structure, the access door comprising a lock assembly.

15. The retail structure of claim 1, further comprising a side awning, the side awning comprising:
a rectangular side awning panel horizontally pivotally coupled along an edge thereof to said second end wall near an upper edge thereof, outside of said structure, the side awning panel being substantially rigid and configured to be pivotally moved between:
an open configuration wherein the side awning panel is substantially horizontal; and
a closed configuration wherein the side awning panel is substantially parallel and adjacent to the second end wall.

16. The retail structure of claim 1, further comprising:
a releasably affixable stair assembly, optionally affixed at one end at or near an upper edge of said first end wall, outside of said structure, with another end of the stair assembly resting on the ground; and
a set of railing elements, pivotally connected to or near to edges of said roof portion;
wherein the railing elements are movable into an upright configuration, thereby defining and enclosing on top of the roof portion a balcony or folded down to rest on the roof portion.

17. The retail structure of claim 1, wherein said retail structure is part of a motorized vehicle, the motorized vehicle further comprising a cabin portion.

18. The retail structure of claim 17, wherein said first end wall of said structure is shared with the cabin portion of the motorized vehicle, wherein said first end wall further comprises a cabin access door to access the vault area from the cabin portion; and wherein said second end wall of said structure is the rear end of the motorized vehicle.

19. The retail structure of claim 17, wherein said second end wall of said structure is shared with the cabin portion of the motorized vehicle, wherein said second end wall further comprises a cabin access door to access the service area from the cabin portion; and wherein said first end wall of said structure is the rear end of the motorized vehicle.

20. The retail structure of claim 19, wherein at least a portion of said vault wall is hingedly connected to at least one of said first side wall or said second side wall, and operable to be pivotally moved so as to be parallel and substantially adjacent to said at least one of said first side wall or said second side wall.
